(19) United States
(12) Patent Application Publication
(10) Pub. No.: US 2007/0218420 A1
(43) Pub. Date: Sep. 20, 2007

(54) Endodontic instrument with non-conductive coating and method for locating the apex of a tooth

(76) Inventor: Philip John Syribeys, Atlanta, GA (US)

Correspondence Address: LAW OFFICES OF DAVID M. LANG, 2230 MINDEN WAY, SACRAMENTO, CA, 95835, US

(21) Appl. No.: 11/701,891

(22) Filed: Feb. 3, 2007

Related U.S. Application Data
(60) Provisional application No. 60/783,178, filed on Mar. 16, 2006.

(51) Int. Cl. A61C 3/00; A61C 5/02

(52) U.S. Cl. 433/32; 433/102

(57) ABSTRACT

An electrically conductive endodontic instrument coated with a non-conductive layer on a portion of the instrument wherein a proximal and distal portion of the instrument remain uncoated and capable of conducting current therethrough using a traditional apex locator or other alerting means. The non-conductive coatings avoid electrical interference from prior restorative work and anatomical variants. The coatings may be smooth to minimize resistance in the endodontic working space or relatively abrasive to facilitate filing where desired. A method for locating the apex of a tooth utilizing an endodontic instrument coated with an electrically non-conductive layer wherein a proximal and distal portion of the instrument remain uncoated and wherein the instrument is advanced in a root canal space toward the apex of a tooth. When the distal portion of the file makes contact with the apex, and a conductive portion of the file is placed in electrical contact with an apex locator, or other alerting means, said contact actuates an alert thereby establishing canal depth while the coated portion of the instrument avoids electrical artifact from prior restorative work and variant anatomy.

### CROSS-REFERENCE TO RELATED APPLICATIONS

This application claims the benefit under 35 U.S.C. §119(e), to U.S. Provisional Application US60/783,178, filed Mar., 16, 2006, entitled “ENDODONTIC FILE WITH THIN FILM NON-CONDUCTIVE COATING” which is incorporated by reference into this application as if fully set forth herein.

### FIELD OF THE INVENTION

The present invention relates to human and animal health care and, more particularly, dentistry and endodontics within that field.

### DESCRIPTION OF THE RELATED ART

When treatment of a diseased tooth requires endodontic treatment, it is necessary to accurately determine the length of a human or animal root canal to prevent over/under instrumentation and over/under filling. Many devices and techniques address measurement of root canal length, however, these devices and techniques are limited by their functionality and accuracy.

For example, one traditional method of determining the length of a tooth, referred to as radiographic length, utilizes a ruler and a two dimensional X-ray of the tooth to measure the distance from the incisal edge to the apex of the tooth. Given the need for an accurate measurement of the canal, and the relative imprecision of radiographic representations, radiographic length is an imperfect method for determining canal length. A variant method involves instrumentation of the tooth to facilitate approximation of length. For example, radiographs taken after insertion of a radiopaque endodontic file, having a stopper, into the root canal space will increase radiographic contrast for more accurate measurement and interpretation. Endodontic working length measurements are then taken directly from the endodontic file utilizing the stopper as a reference point. Despite the required exposure to radiation during the x-ray and subjective operator interpretation, the radiographic length remains the standard of care by which all root canal measurements are evaluated.

Recently, electronic apex locaters have been developed to facilitate measurement of the working length of endodontic canal spaces. For example, Mousseau, U.S. Pat. No. 3,916,529 teaches a method and instrument for determining the length of a root canal wherein a thin flexible metal wire, electrically coupled to a power source and current meter, is introduced into the root canal of the tooth and advanced until the probe's tip reaches the root apex. On making contact with the apex, a value is reached signifying tissue contact, as determined through a prior calibration step, wherein the metal wire is placed in electrical contact with the interface of soft gum tissue and the tooth at the base of the tooth. In this way, electronic apex locaters pass a small current through a conductive endodontic file and a grounding electrode attached to the patient, where electrical resistance is measured as the instrument is positioned in the canal space. Existing electronic apex locaters utilize an instrument, such as a thin wire, an endodontic file, or metal tool as a conductive probe. Electronic apex locaters thus exploit the electrical properties of enamel and dentin: dentin and enamel are poor conductors of electricity while the cellular fluid and interstitial fluid of the periapical tissue surrounding the root apex are relatively good conductors of electricity.

While electronic apex locaters are helpful in determining canal length, they have limitations. For example, artifactual readings occur when the endodontic file, wire, or instrument body makes contact with conductive bodies other than the periapical tissue surrounding the root apex. Contact with electrically conductive bodies such as silver amalgam fillings, porcelain fused to metal crowns, or large lateral canals may register erratic ammeter readings. Furthermore, not infrequently, a patient will have multiple sources of conductive interference which together further diminish the utility of electronic apex locaters. Unfortunately, existing conductive instrument/apex locater systems do not adequately address the problem of electrical interference from conductive restorative materials, abhorrent dental anatomy, lateral canals existing as anatomic variants in normal dentition, and the inherent problem of poor isolation when treating severely decayed teeth.

Accordingly, a need exists for an improved instrument and method to measure the length of a root canal that minimizes or eliminates electrical interference from prior restorative work or anatomical variants. Further, a need exists for an instrument which is easy to manufacture and utilize by a practicing dentist, veterinarian, or other health professional. What is further needed is an instrument which may be easily and effectively introduced into the narrow space of a root canal. What is additionally needed is an instrument that will assist in determining the proper length of a root canal and minimize or eliminate both under/over instrumentation and under/over filling of a canal during endodontic treatment.

### SUMMARY OF THE INVENTION

It is therefore a primary object of the present invention to provide an improved line of dental instruments for determination of root canal length.

The present invention utilizes an electrically non-conductive coating applied to dental instruments to minimize the problem of electrical interference. A further object of the invention is to provide a variety of instrument coatings with differing surface textures and abrasiveness, said coatings meeting the varied clinical needs of the dentist. Another object of the present invention is to provide an array of coated instruments with varied dimensions, including variation at the most distal conductive portion, said variations related to the size of the canal space to be examined. Another object of the invention is to reduce the time of endodontic procedures through use of a coated dental instrument which doubles as a depth monitor. Yet another object of the invention is to provide a method for locating the apex of a tooth utilizing a dental instrument coated with a non-conductive coating for use in conjunction with an electronic apex locator device or other alerting means.

It is intended that any other advantages and objects of the present invention that become apparent or obvious from the detailed description or illustrations contained herein are within the scope of the present invention.

### BRIEF DESCRIPTION OF THE DRAWINGS

FIG. 1 is a front elevation view of the present invention illustrating the coating location in a preferred embodiment.

FIG. 2 is a side elevation view depicting the coated instrument within the canal of a tooth model in cross-section, demonstrating prior restorative work and variant anatomy, and a schematic of use with an alerting means.

FIG. 3 is a side elevation view depicting the coated instrument within the canal of a tooth model in cross-section, demonstrating sources of electrical interference.

FIG. 4 is a cross-section view depicting an alternative embodiment.

### DETAILED DESCRIPTION OF THE PREFERRED EMBODIMENT AND ALTERNATIVE EMBODIMENTS

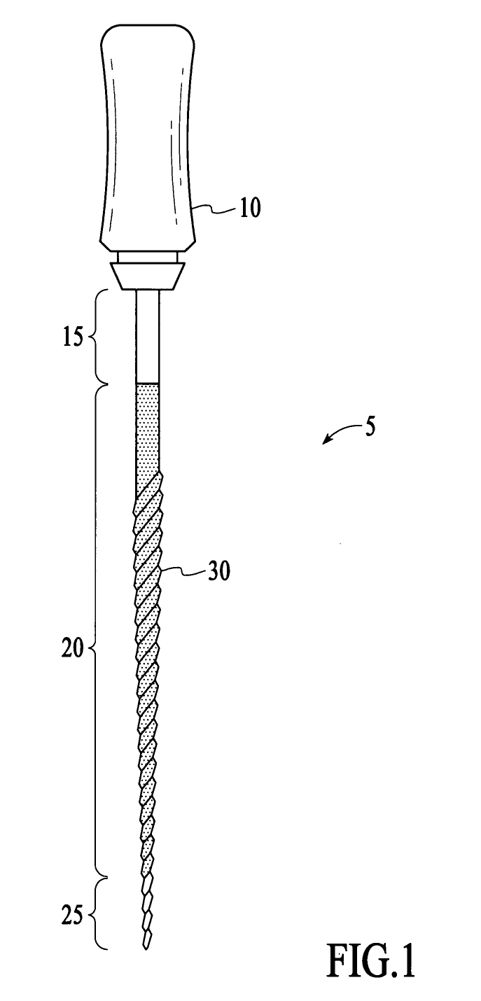

Referring now descriptively to the drawings, the attached figures illustrate example embodiments of the present invention. FIG. 1 depicts an example dental instrument with an electrically insulating, non-conductive coating. To illustrate the present invention, a non-limiting example dental file will be used herein as an exemplar instrument. The example file referred to generally as 5 has a handle 10, an electrically conductive shaft having a proximal conductive portion 15, coated non-conductive portion 20, a distal conductive portion 25, and, in this exemplar instrument, a filing portion 30 is also depicted. Non-conductive portion 20 is formed where non-conductive media is placed, preferably, uniformly and circumferentially along the conductive shaft thereby laminating the surface and rendering it non-conductive. The proximal conductive portion 15 and distal conductive portion 25 are not coated with non-conductive media. In a preferred embodiment, the proximal conductive portion 15 measures about 3 millimeters in length, although this merely represents the standard file clamp typically used in the industry, and is arbitrary with respect to the scope of the present invention.

The dimensions of distal conductive portion 25 relate directly to the size of the canal space to be examined. Root canals with larger diameters, such as those found in palatal roots and maxillary central incisor root canal spaces, utilize an endodontic file where distal conductive portion 25 measures from about 0.5 millimeter to about 1 millimeter in length. Root canals with smaller diameters, such as those found in mandibular central incisors and the mesial roots of molars, require distal conductive portion 25 to measure about 2 or 3 millimeters, depending on canal space diameter. Thus the dimensions of distal conductive portion 25 directly relate to the size of the canal space to be examined.

In a preferred embodiment, the thickness of the non-conductive coating 20 itself need not exceed 200 nanometers to inhibit the electrical conductivity properties of the instrument. However, it should be noted that the non-conductive coating 20 might be quite thick. Film thickness is limited only by the clinical utility of such an instrument with a larger cross-sectional diameter attributable to the layer. Given the inherent variations of root canal size, utilizable film thickness is guided by an individual clinical application. An instrument coated with a relatively thick layer of insulating media may have difficulty navigating the smallest portions of one canal while the identical instrument may be quite appropriate and serve well for another. One advantage to a thicker coating is that it may be more durable and resistant to corrosive effects during the cleaning. Accordingly, the invention may be practiced with a wide range of coating thicknesses.

Regarding the instruments, typically standard dental instruments are comprised of stainless steel or nickel titanium. A wide variety of instruments types may be coated, the simplest instrument being a metal wire which, at its most basic, is capable of locating the apex of a tooth. As a non-limiting example, a preferred embodiment of the present invention places a non-conductive coating on traditional dental files, including but not limited to reamers, K-Files, and Hedstrom files.

Accordingly, endodontic files, partially laminated with a non-conductive electrically insulating coating, allow the dentist to enlarge and shape the canal while at the same time monitoring canal depth—without the need to switch instruments as required through prior art approaches. In this way, the present invention not only ensures a more efficient and refined approach to securing proper canal depth, by minimizing over/under filling and over/under instrumentation, it saves the dentist and patient considerable time during endodontic procedures.

Regarding coating composition, the instruments may be coated with a variety of non-conductive electrical insulators. As non-limiting examples, the coating may be comprised of silica, silicone, alumina, diamond, diamond-like films, insulating ceramics, carbon and carbon-based films, Polytetrafluoroethylene (PTFE), or other electrically non-conductive material laminating non-conductive portion 20. In one preferred embodiment, the non-conductive coating is comprised of silica or silicon dioxide. Silica based coatings applied to instruments decrease friction and provide a relatively slippery instrument that readily slides in and out of the canal; this aids in the negotiation of relatively small, tight canal spaces. In contrast, abrasive films have unique properties and clinical utility. For example, the application of Alumina and/or Aluminum Oxide films yields an instrument coated with an abrasive layer. Similarly, diamond, diamond-like layers, and carbon-based films may provide an abrasive coating that assists in widening the canal where clinically appropriate and desired. The abrasive coatings are most advantageous where the user seeks to enlarge the canal while frequently monitoring canal depth. In this way, the integration of coating-augmented filing and depth-monitoring is particularly useful in further reducing the time of endodontic procedures. Application of the abovementioned coatings, for example, through various thin-film deposition techniques, is well recognized in the prior art. Any number of techniques may be used to deposit the coating layer on the instrument.

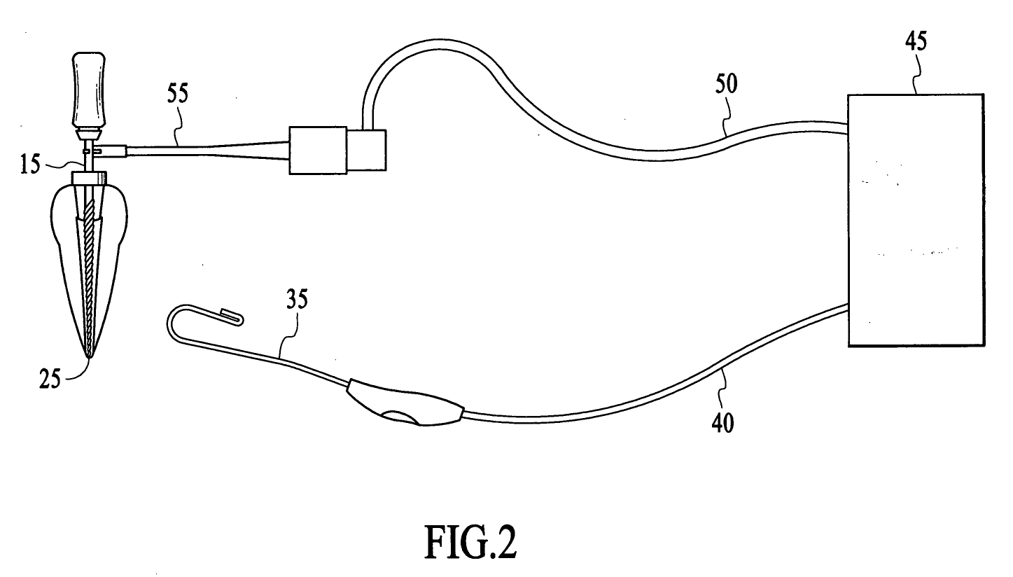

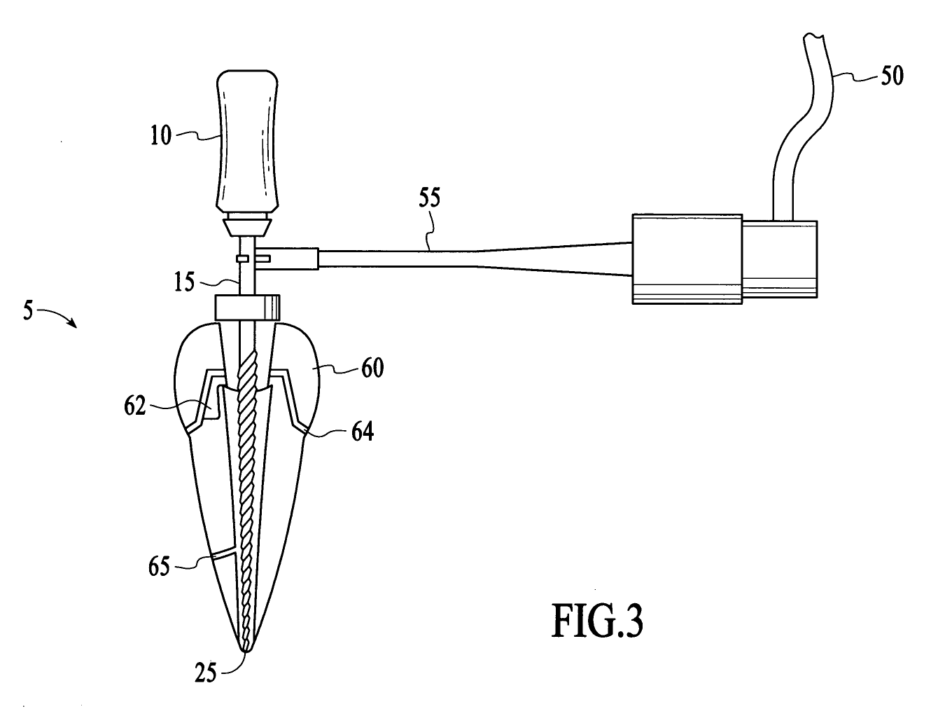

Regarding the apex locating system, FIGS. 2 and 3 illustrate an electrically conductive dental instrument 5 comprising a proximal conductive portion 15, middle non-conductive portion 20, and distal conductive portion 25, wherein said middle portion 20 is coated with a non-conductive coating. Next, FIG. 2 demonstrates a first electrical contact 35 and a second electrical contact, 55 wherein the first contact 35 is capable of being placed in electrical contact with a patient's gumline and the second contact 55 is capable of being placed in electrical contact with the proximal conductive portion 15 of said instrument 5. Next, an alerting means 45 is electrically coupled to said first contact 35 and second contact 55, preferably through electrically insulated wires 40, 50 respectively. A power source is placed in electrical contact with said insulated wires 40, 50. The power source may be integrally incorporated withing the alert means, or may be freestanding. It should be noted that the location of the power source and alert means is arbitrary. In an alternative embodiment, a power source may be located adjacent to or incorporated into a modified first or second contact 35, 55 respectively. Similarly, the alert means 45, may be located adjacent to or incorporated into a modified first or second contact 35, 55 respectively. The alert means 45 and power source may be located adjacent to or apart from each other. The present invention may be practiced with the alerting means and power source in any configuration capable of forming a completed circuit.

Regarding a preferred embodiment illustrated by FIGS. 2 and 3, the apex locating system utilizes a conventional apex locator 45 as the alert means, and an electrically conductive dental file 5. File 5 is comprised of a proximal conductive portion 15, middle non-conductive portion 20, and distal conductive portion 25, wherein said middle portion 20 is coated with a non-conductive thin-film coating of about 200 nanometers in thickness. Next, conductor 35 is capable of being placed in electrical contact with a patient's gumline and probe end 55 is capable of being placed in electrical contact with the proximal conductive portion 15 of said instrument 5. Next, a conventional apex locator having a power source 45 is electrically coupled to said first contact 35 and second contact 55, through electrically insulated wire 40 and file end probe cord 50.

Regarding the specific example method of locating the apex of a tooth, FIG. 2 illustrates a conductor 35 which may be placed over the patients lip or maintained in electrical contact with the gum line; this is facilitated by deposition of water or saliva on conductor 35 prior to placement. Conductor 35 is coupled to the first end of an electrically insulated wire 40 the second end of which is coupled to a conventional apex locator 45 having a power source. A first end of a file end probe cord 50 is likewise coupled to apex locator 45, and a second end of file end probe cord 50 is coupled to a probe end 55. When measurement of the canal depth is desired, the coated instrument 5, having a proximal conductive portion 15, a middle non-conductive portion 20 coated with a non-conductive coating, and distal conductive portion 25, is introduced into the root canal space of a tooth. Instrument 5 is advanced inferiorly toward the apex to the desired depth. Probe end 55 is placed in electrical contact with proximal conductive portion 15. Additionally, file 5 may be advanced inferiorly while probe end 55 is maintained in electrical contact with a conductive portion of instrument 5 until the moment the apex is reached by the distal conductive portion 25 as determined by a positive reading on the conventional apex locator 45, where it necessarily follows that resistance has decreased sufficiently to permit current to flow through the competed circuit.

FIG. 3 illustrates numerous sources of potential electrical interference from prior restorative work and variant anatomy generally. Specific examples of interfering restorative materials include, as examples only, conductive direct restorative material 62, for example silver amalgam filling or silver impregnated glass ionomer material. Additionally, conductive metal coping 64 is fused to a crown surface 60 which is typically comprised of porcelain. In this case coping 64 is electrically conductive and file 5 is substantially electrically shielded by non-conductive layer 20. With a traditional all-metal crown (for example an all-gold crown) surface 60 and coping 64 are both comprised of a conductive metal, and non-conducting layer 20 substantially prevents electrical contact between file 5 and surface 60 and/or coping 64. Distal conductive portion 25 is capable of conducting electricity. However, the relatively modest size of distal conductive portion 25 results in far less if any electrical interference when compared to uncoated prior art files where the entire file is conductive.

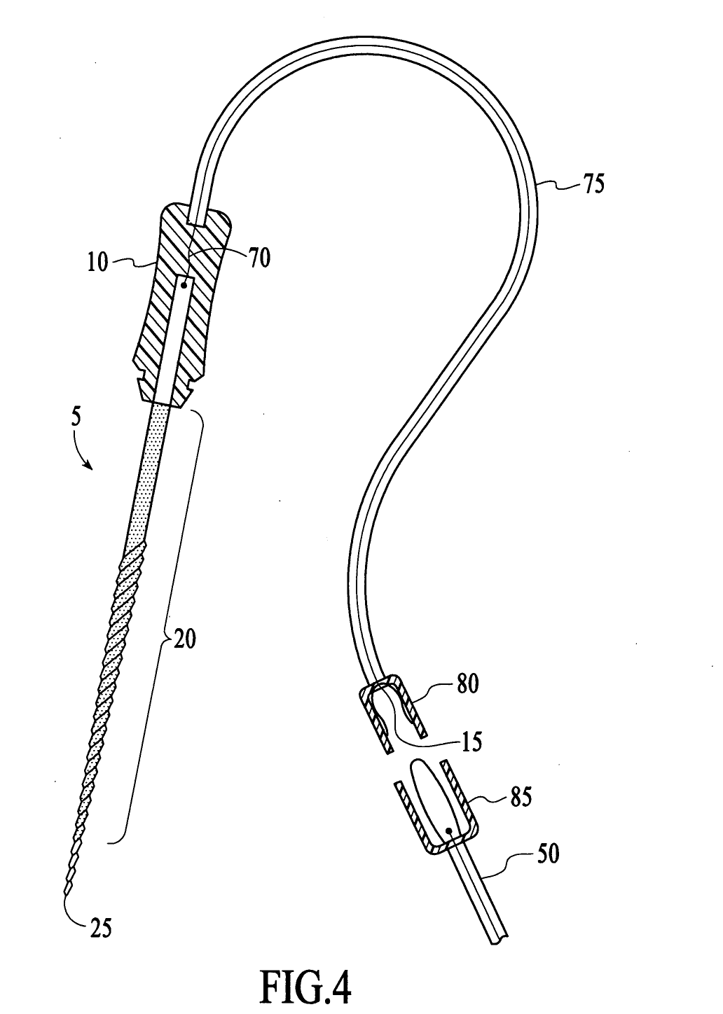

In an alternative embodiment, the proximal conductive portion 15 is extended from the file itself. For example, FIG. 4 illustrates an exemplar alternative embodiment. A conducting wire 70 is soldered to file 5 within a non-conducting handle 10 mounted on the most proximal portion of file 5 wherein an uncoated region of file 5 is completely disposed within handle 10. Conducting contact wire 70 is electrically coupled to a standard insulated flexible wire 75 where contact wire 70 is completely disposed within said handle said wire having a first end and second end wherein said first end is electrically coupled to said file disposed within said handle. An insulated flexible wire 75 is electrically coupled to said second end of contact wire 70, contact wire 70 being completely disposed within said handle, at least a portion of said flexible wire 75 being disposed within said handle The terminal end of flexible wire 75 may be placed in electrical contact with the probe end cord 50 or probe end 55. As an example preferred embodiment, FIG. 4 illustrates use of a pair of mated couplers. Flexible wire 75 leaves handle 10 and terminates in a first insulated electrical coupler 80, adapted to reversibly electrically couple to a corresponding second electrical coupler 85 which is in electrical contact with probe end cord 50 followed by apex locator 45. Where a coupling scheme similar to that illustrated by FIG. 4 is utilized, the proximal conductive portion 15 is the conductive portion of the first coupler 80 itself.

The extension of proximal conductive portion 15 does not require that the contact point is embedded within file handle 10. An electrical contact, small wire, or filament, may be placed in contact with the proximal end of the file. The proximal end of the file, with an attached contact, wire, or filament may then be laminated over leaving only the end of the contact, wire, or filament exposed at the end furthest from the file (not shown). In this alternative embodiment, the proximal conductive portion 15 is that portion of the contact, wire, or filament which is not covered by laminate or insulation and in a specific alternative embodiment, the most distal end of said contact, wire, or filament serves as the operative point of contact for establishing contact with probe end 55 or file end probe cord 50. In yet another alternative embodiment, the file may be shaped so as to define a relatively thin projection, which serves as an electrical contact. Only that portion of the projection furthest from the working shaft of the file need remain uncoated with laminate for the alternative embodiment proximal conductive portion to be operational (not shown).

It should be recognized that apex locator 45 may be omitted and an alternative alerting means and power source employed. An alternative alerting means may be placed in electrical contact with conductor 35 and probe end cord 50 or probe end 55 to alert the dentist when the apex has been reached. For example, Inoue U.S. Pat. No. 3,660,901 teaches the use of an audible signal when a probe reaches the root apex. Other prior art devices employ the use of a light to signal when the apex has been reached. Various types of alert means are known in the prior art. The present invention may be practiced with any type of alert means capable of producing illumination, sound, or vibration, when the circuit is closed. Such example alert devices offer the practical advantage in that the dentist is not required to divert attention from the working environment to monitor an apex locator. This may foster a more economical work environment and save yet additional time during endodontic procedures.

Turning now to the method of production, the insulating thin-film coating may be placed uniformly on non-conductive portion 20 of an instrument, and specifically on an endodontic, file via standard deposition methods, including specifically several thin-film techniques. Several exemplar methods include sputtering, chemical vapor deposition (CVD), molecular beam epitaxy, Sol-Gel Process, spin coating, pulsed laser deposition. Regarding CVD Atmospheric pressure, atomic layer, aerosol-assisted CVD, direct liquid injection, hot wire, low-pressure, metal-organic CVD, microwave plasma-assisted, plasma-enhanced, rapid thermal, remote plasma-enhanced, ultrahigh vacuum, are all non-limiting examples of production methods. Hunt, et al, U.S. Pat. No. 6,013,318, expressly incorporated herein by this reference, discloses several exemplar methods for thin-film deposition and teaches application of film coatings to substrates using Combustion Chemical Vapor Deposition.

Combustion Chemical Vapor Deposition (CCVD) offers several advantages to other application methods, and is a preferred method of depositing non-conductive coatings in the present invention. CCVD process is relatively simple and inexpensive when compared to other chemical vapor deposition methods. First, CCVD does not require a furnace and is conducted in an open-atmosphere environment. Second, unusual shapes may be coated incompletely depending on direction of the flame relative to the instrument. This is particularly helpful in the present invention which depends upon an incompletely coated instrument with coating terminated relatively precisely at the proximal 15 and distal 25 conductive portions in a preferred embodiment. Third, because a patient's canal spaces will vary, it is advantageous to produce instruments with varied proximal 15 and distal 25 conducting portions dimensions, as well as varying degrees of coating thickness; CCVD permits coating 20 to be deposited in a variety of lengths and thicknesses.

Although the present invention has been described with reference to the preferred embodiments, it should be understood that various modifications and variations can be easily made by those skilled in the art without departing from the spirit of the invention. Accordingly, the foregoing disclosure should be interpreted as illustrative only and is not to be interpreted in a limiting sense. It is further intended that any other embodiments of the present invention that result from any changes in application or method of use or operation, method of manufacture, shape, size, or material which are not specified within the detailed written description or illustrations contained herein yet are considered apparent or obvious to one skilled in the art are within the scope of the present invention.

What is claimed is:

1. An endodontic instrument comprising:
an electrically conductive shaft having a proximal portion, distal portion, and a middle portion; and
an electrically non-conductive coating applied to the surface of said middle portion;
wherein said proximal and distal portions of said shaft remain uncoated.

2. The endodontic instrument of claim 1, wherein said shaft is comprised of an electrically conductive wire.

3. The endodontic instrument of claim 2, wherein said coating is comprised of silicon oxide.

4. The endodontic instrument of claim 1, wherein said at least a portion of said shaft is comprised of a dental file.

5. The endodontic instrument of claim 4, wherein said file is a Hedstrom file.

6. The endodontic instrument of claim 4, wherein said file is a K-File.

7. The endodontic instrument of claim 4, wherein said coating is comprised of silicon oxide.

8. The endodontic instrument of claim 5, wherein said coating is comprised of silicon oxide.

9. The endodontic instrument of claim 6, wherein said coating is comprised of silicon oxide.

10. The endodontic instrument of claim 4, wherein said coating is comprised of aluminum oxide.

11. The endodontic instrument of claim 5, wherein said coating is comprised of aluminum oxide.

12. The endodontic instrument of claim 6, wherein said coating is comprised of aluminum oxide.

13. The endodontic instrument of claim 4, wherein said coating is comprised of diamond like carbon.

14. The endodontic instrument of claim 5, wherein said coating is comprised of diamond like carbon.

15. The endodontic instrument of claim 6, wherein said coating is comprised of diamond like carbon.

16. The endodontic instrument of claim 4, wherein said coating is comprised of diamond.

17. The endodontic instrument of claim 5, wherein said coating is comprised of diamond.

18. The endodontic instrument of claim 6, wherein said coating is comprised of diamond.

19. The endodontic instrument of claim 2, wherein said coating is comprised of insulating ceramics.

20. The endodontic instrument of claim 4, wherein said coating is comprised of insulating ceramics.

21. The endodontic instrument of claim 5, wherein said coating is comprised of insulating ceramics.

22. The endodontic instrument of claim 6, wherein said coating is comprised of insulating ceramics.

23. The endodontic instrument of claim 4, wherein said coating is about 200 nanometers thick.

24. The endodontic instrument of claim 4, further comprising:
a handle mounted on the most proximal portion of said file wherein an uncoated portion of said file is completely disposed within said handle;
a contact wire completely disposed within said handle said wire having a first end and second end wherein said first end is electrically coupled to said file portion disposed within said handle;
an insulated flexible wire electrically coupled to said second end of contact wire the contact wire being completely disposed within said handle, wherein at least a portion of said flexible wire is disposed within said handle, and wherein an electrically conductive portion of the opposite end of said insulated flexible wire comprises said proximal conductive portion.

25. An apex locating system comprising:
an electrically conductive dental file comprising a proximal conductive portion, a middle, non-conductive portion, and distal conductive portion, wherein said middle portion is coated with a non-conductive thin-film coating of about 200 nanometers in thickness, and wherein said proximal conductive portion and distal conductive portion of said file remain uncoated;
a first contact and a second contact wherein said first contact is capable of being placed in electrical contact with a patient's gumline and the second contact is capable of being placed in electrical contact with the proximal conductive portion of said file;
an alerting means electrically coupled to said first contact and second contact;
a power source electrically coupled to said first contact and second contact.

26. A method of locating the apex of a tooth comprising:
(a) placing a conductor in electrical contact with a patient's lip or gumline;
(b) coupling said conductor to a first end of an electrically insulated wire;
(c) coupling a second end of said electrically insulated wire to an apex locator;
(d) coupling a first end of a file end probe cord to said apex locator;
(e) coupling a second end of a file end probe cord to a probe end;
(f) inserting an electrically conductive dental instrument, having a proximal conductive portion, a middle non-conductive portion coated with a non-conductive coating, and distal conductive portion, into the root canal space of a tooth;
(g) advancing said instrument inferiorly toward the tooth apex to the desired depth;
(h) placing probe end in electrical contact with said proximal conductive portion of said dental instrument when a user seeks to determine if the apex has been reached.

27. The method of claim 26, further comprising: advancing said instrument inferiorly while said probe end is maintained in electrical contact with said proximal conductive portion of said dental instrument until such time the apex is reached by the distal conductive portion of said instrument as determined by a positive reading on the apex locator, whereby resistance has decreased sufficiently to permit current to flow through the completed circuit.
